(19) United States
(12) Patent Application Publication
(10) Pub. No.: US 2013/0127586 A1
(43) Pub. Date: May 23, 2013

(54) TEMPERATURE-DEPENDENT SWITCH

(71) Applicant: Marcel P. Hofsaess, Sondershausen (DE)

(72) Inventor: Marcel P. Hofsaess, Sondershausen (DE)

(21) Appl. No.: 13/674,973

(22) Filed: Nov. 13, 2012

(30) Foreign Application Priority Data
Nov. 22, 2011 (DE) 10 2011 119 633.5

(51) Int. Cl. H01H 37/54

(52) U.S. Cl. CPC H01H 37/54
USPC 337/365

(57) ABSTRACT

A temperature-dependent switch has a housing which has an upper part with a first outer surface and a lower part with a second outer surface, and a temperature-dependent switching mechanism which is arranged in the housing and, as a function of its temperature, establishes or opens an electrically conductive connection between two outer connections. A pressure-uptaking structure is arranged on the outside of the upper part and/or the lower part, said pressure-uptaking structure protruding approximately perpendicularly outwards beyond the first and/or second outer surface.

This application claims priority to German patent application DE 10 2011 119 633, filed Nov. 22, 2011, which is incorporated herein by reference.

### BACKGROUND OF THE INVENTION

The present invention relates to a temperature-dependent switch comprising a housing which has an upper part with a first outer surface and a lower part with a second outer surface, and comprising a temperature-dependent switching mechanism which is arranged in the housing and, as a function of its temperature, establishes or opens an electrically conductive connection between two outer connections, a pressure-uptaking structure being provided that protrudes outwards beyond at least one the first and second outer surfaces.

A switch of this kind is known from U.S. Pat. No. 5,268,664 A.

The known temperature-dependent switch, like the switch known from EP 0 651 411 B1, is used, in a manner which is known per se, to monitor the temperature of an appliance. To this end, it is brought into thermal contact with the appliance, which is to be protected, for example by means of the outer surfaces such that the temperature of the appliance which is to be protected influences the temperature of the switching mechanism.

The switch is connected electrically in series in the electrical supply circuit of the appliance which is to be protected, so that below the response temperature of the switch the supply current of the appliance which is to be protected flows through the switch.

If the temperature of the appliance now increases impermissibly above a predefined switching threshold, the switching mechanism opens the electrical connection between the two outer connections of the switch and the flow of current is interrupted, so that the appliance which is to be protected is switched off and cannot heat up any further.

The switch is electrically connected to the electrical circuit of the appliance which is to be protected either directly by means of the two outer surfaces, when the upper part and the lower part are produced from electrically conductive material, or by means of contacts which are provided on the outer surfaces and to which litz wires, for example, are soldered.

The two outer connections can be provided directly on the upper part and on the lower part, and in this case the current generally flows through the temperature-dependent switching mechanism itself. It is known to equip switching mechanisms of this kind with a spring snap-action disc and a bimetallic snap-action disc. In this case, the spring snap-action disc is fitted with a so-called moving contact part which presses the spring disc against a stationary contact on the inside of the upper part. The spring snap-action disc is supported in the lower part of the housing by way of its edge, and therefore the electric current flows from the lower part, through the spring snap-action disc and the moving contact part, into the stationary contact, and from there into the upper part.

Secondly, it is also known to fit a so-called contact bridge to the spring snap-action disc, the said contact bridge being pressed by the spring snap-action disc against two stationary contacts, which are provided on the upper part. In this case, the current flows from one stationary contact, through the contact bridge, into the other stationary contact, and therefore the operating current does not flow through the spring snap-action disc itself.

This design is selected particularly when very high currents have to be switched, which cannot be conducted without problems via the spring disc itself.

In the two design variants, a bimetallic snap-action disc which lies in the switching mechanism such that it is free from forces below its transition temperature is provided for the temperature-dependent switching function, with the said bimetallic snap-action disc being geometrically arranged between the contact part or the contact bridge and the spring snap-action disc.

If the temperature of the bimetallic snap-action disc now increases as a result of a temperature increase in the appliance which is to be protected above the transition temperature, the bimetallic snap-action disc changes its configuration and, by way of its edge, presses against an abutment which is generally provided on the upper part. In the process, the bimetallic snap-action disc presses against the spring snap-action disc by way of its central region and thus lifts the moving contact part away from the stationary contact or lifts the current transfer element away from the two stationary contacts, and therefore the switch is opened.

An example of a temperature-dependent switch having a moving contact part and a stationary contact and in which the current is conducted through the spring snap-action disc is disclosed in DE 21 21 802 A1.

An example of a temperature-dependent switch having a current transfer bridge is described, for example, in DE 26 44 411 A1.

In the case of these designs, the bimetallic snap-action disc is mounted such that it is free from mechanical forces below its transition temperature, with the bimetallic snap-action disc not being used to carry the current in any case either.

In this case, it is advantageous for the bimetallic snap-action discs to have a long mechanical service life and for the switching point, that is to say the transition temperature of the bimetallic snap-action disc, to not change even after a large number of switching operations.

If less stringent requirements in respect of mechanical reliability and stability of the transition temperature can be tolerated, the bimetallic snap-action disc can also take on the function of the spring snap-action disc, so that the switching mechanism comprises only a bimetallic snap-action disc which is then fitted with the moving contact part or the current transfer element and, with the design comprising a moving contact part, in the closed state of the switch, also carries the current.

Furthermore, it is known to provide switches of this kind with a parallel resistor which is connected in parallel with the outer connections. When the switch is open, this parallel resistor takes over a part of the operating current and keeps the switch at a temperature above the transition temperature, so that the switch does not automatically close again after cooling down. Switches of this kind are called self-holding.

It is also known to equip switches of this kind with a series resistor, the operating current which flows through the switch also flowing through the said series resistor. Ohmic heat which is proportional to the square of the flowing current is generated in the series resistor in this way. If the current intensity exceeds a permissible amount, the heat of the series resistor leads to the switching mechanism being opened.

In this way, an appliance which is to be protected is already disconnected from its electrical supply circuit when an excessively high current which has not yet led to excessive heating of the appliance is observed.

All of these different design variants can be realized with the switch according to the invention; in particular, the bimetallic snap-action disc can also take on the function of the spring snap-action disc.

The switch known from EP 0 651 411 B1, mentioned at the outset, has a deep-drawn lower part in which an internal circumferential shoulder is provided, a cover part being situated on the shoulder. The cover part is held firmly on this shoulder by a raised and beaded edge of the lower part.

Since the upper part and the lower part are produced from electrically conductive material, an insulating film is also provided between them, the said insulating film extending parallel to the upper part and being raised laterally upwards, so that the beaded edge presses against the upper part with the interposition of the insulating film.

An opening is provided approximately in the center of the insulating film which runs parallel to the upper part, a moving contact part coming into contact with a stationary contact, which is provided on an inner face of the upper part, through the said opening.

In this case, the temperature-dependent switching mechanism comprises a spring snap-action disc which is fitted with the moving contact part, and also a bimetallic snap-action disc which is placed over the moving contact part. The spring snap-action disc is supported, by way of its edge, on an inner circumferential shoulder in the lower part.

An outer shoulder which is recessed in relation to the outer surface of the lower part is provided on the said lower part, a ring of a connection lug being attached to the said shoulder.

In this case, this ring is designed such that it does not protrude outwards beyond the outer surface of the lower part.

The ring is electrically conductively connected to the lower part, so that, in this way, electrical contact is made via the outer connection which is formed by the outer surface of the lower part.

The outer surface of the upper part constitutes the second outer connection to which a connection litz wire is soldered.

Although this switch has many advantages in respect of the connection technique and the manner of operation, certain concerns arise when it is intended to be arranged on an appliance, which is to be protected, such that a high pressure is exerted on one or both of the outer surfaces, for example by windings or heat-contact surfaces of the appliance.

This high pressure leads, specifically, to the lower part possibly bending, particularly when the lower part is a deep-drawn part, this in turn leading to the bearing surface of the edge of the spring snap-action disc bending or shifting, so that reliable electrical contact with a low transfer resistance between the lower part and the spring snap-action disc is no longer ensured in specific cases.

Against this background, the known switches are generally not produced with a lower part which has been deep-drawn, but rather with a turned lower part which is produced in a considerably more solid and precise manner than a deep-drawn lower part.

However, these turned lower parts are considerably more expensive than deep-drawn lower parts both in respect of material costs and production costs.

Pressure on the outer surface of the upper part can additionally lead to the position of the stationary contact or of the two stationary contacts in relation to the switching mechanism changing, so that the switching mechanism can no longer be reliably opened or that the opening distance is reduced such that an undesirably long arc is often produced when the switch is opened.

The switch known from U.S. Pat. No. 5,268,664 A, mentioned at the outset, has a cup like lower part housing the switching mechanism, and a flat cover. A flange of the lower part and a flange of the cover are lying one upon the other, extend laterally over the cup, and are folded under twice to form a side flange having a thickness that is increased to slightly more than the thickness of the cup. If any pressure is put onto the switch, by surrounding components, the folded side flange shall absorb the pressure, rather than the cup.

The housing of the known switch is of complicate design and difficult and costly to assemble. Further, the transverse dimensions of the known switch are increased to much more than the diameter of the cup, so that the known switch is not suited for many applications.

U.S. Pat. No. 5,808,539 A discloses a temperature-dependent switch having a cup-like lower part with an outwardly extending flange around its periphery, said cup housing a switching mechanism. A flat cover separated from the flange by a ring-shaped gasket has a peripheral portion mating with the flange. The peripheral portion, the gasket and the flange are cured together by applying heat.

From the drawing it seems that the peripheral portion of the cover projects by a small amount over the flat upper surface of the cover.

### SUMMARY OF THE INVENTION

In view of the above, it is an object of the present invention to increase in the known switch the stability against pressure in a structurally simple and cost-effective manner.

According to the invention, this and other objects are achieved with the switch mentioned at the outset in that the pressure-uptaking structure is provided on the outside of the upper part and/or the lower part, the said pressure-uptaking structure protruding approximately perpendicularly outwards beyond the first and/or second outer surface, such that pressure acting on the switch from the outside is conducted into wall-regions of the lower part and/or upper part.

The inventor has therefore specifically not taken the approach of reinforcing the housing from the inside or equipping it with thicker walls.

Namely, the inventor of the present invention has recognized that a pressure-uptaking structure, which is preferably arranged in the edge region of the lower part and possibly of the upper part, can conduct the pressure acting on the switch from the outside into the regions of the walls of the lower part and/or upper part, so that bending of the base region of the lower part or of the cover region of the upper part is avoided, without the walls thereof having to be reinforced.

According to one object, the pressure-uptaking structure projects beyond the outer surface by less than 1/10 mm.

Namely, the inventor of the present application has recognized that a projecting length of 1/100 mm to 1/10 mm is sufficient in order to not conduct the pressure onto the outer surface but rather into the wall of the lower part or upper part by means of the pressure-uptaking structure, with, secondly, this short projecting length not adversely affecting the thermal connection of the temperature-dependent switch to the electrical appliance which is to be protected, or doing so only to an insignificant extent.

According to a further object, an outer shoulder which is recessed in relation to the first and/or second outer surface is provided on the upper part and/or the lower part, the pressure-uptaking structure being attached to the said shoulder.

The advantage of this measure is that the recessed outer shoulder is provided in the region of the peripheral wall of the lower part or upper part, with an accommodation location for the pressure-uptaking structure also already being provided by the peripheral shoulder.

A circumferential shoulder of this kind is known, for example, from EP 0 651 411 B1, with said document expressly requiring that the ring of the connection lug, which ring is attached to the said recessed shoulder, does not protrude outwards beyond the outer surface of the lower part.

The inventor of the present application has now recognized that it is possible to design the ring to be, as it were, somewhat thicker, so that it projects beyond the outer surface by 1/100 to 1/10 mm.

As before, electrical contact can be made with the lower part by means of the connection lug via the said ring, while the ring at the same time conducts a pressure, which is exerted on the switch from the outside, into the wall structure. Therefore, the pressure-uptaking structure may also be termed a pressure-conducting or a pressure-transferring structure. Nevertheless—contrary to the assumption in EP 0 651 411 B1—the thermal connection to the appliance which is to be protected is sufficient. This was not expected in the prior art up to date.

According to another object, the pressure-uptaking structure comprises an annular structure which is preferably connected to a connection lug, further preferably is integrally connected to the connection lug.

This measure, taken on its own, is known from EP 0 651 411 B1. By virtue of said measure, the advantage of the simple connection technique is now associated with the advantage of the base and possibly the cover of the new switch being protected, by means of a somewhat thicker ring, against deformations due to pressure which is applied from the outside.

However, when the switching mechanism does not conduct the current through the spring snap-action disc or the bimetallic snap-action disc but rather through a current transfer element, the annular structure serves only to protect the base and possibly the cover of the new switch against deformations due to pressure which is applied from the outside.

Therefore, it is now possible to design both the lower part and the upper part as deep-drawn parts, so that they can be produced in a simple and cost-effective manner.

Providing a recessed outer shoulder during production of the deep-drawn part on the lower part and possibly also on the upper part does not require an additional measure, it is only necessary to produce a corresponding shaping die for the lower part and/or upper part once.

Owing to the pressure being conducted away via the pressure-uptaking structure, it is now possible to use deep-drawn parts, instead of the turned parts preferred in the prior art up to date, while retaining at least the same stability to pressure, if not an even higher stability to pressure.

According to a still further object, a first circumferential wall is provided on the upper part and a second circumferential wall is provided on the lower part, the said first circumferential wall engaging over the said second circumferential wall.

The advantage of this measure is that the upper part and the lower part can be designed as deep-drawn parts, with the two circumferential walls each absorbing the pressure which is kept away from the outer surface by means of the pressure-uptaking structure which is arranged on the recessed shoulder and, instead, being conducted at least into regions of the circumferential walls.

A switch which is designed according to one embodiment of the invention then has a pot-like lower part and also a similarly pot-like upper part which is placed over the said lower part, with a recessed outer, circumferential shoulder being provided on the base of the lower part and on the cover of the upper part in each case.

An annular structure is in each case attached to this shoulder, said annular structure being used firstly for conducting pressure and secondly for electrically connecting both to the lower part and the upper part.

This design is particularly expedient when no current transfer element but rather a moving contact part with a stationary mating contact is provided.

If the switch according to the invention is intended to be equipped with a switching mechanism for high currents, such that a current transfer element interacts with two stationary contacts on the upper part, the concept according to the invention of the pressure-uptaking structures on the upper part and the lower part can nevertheless be implemented. The rings on the upper part and the lower part then serve only for uptaking pressure; the outer connection is made by means of two outer contacts which pass through the upper part and are electrically connected to the stationary contacts.

If the upper part and the lower part are produced from electrically conductive material, an insulating film is arranged between the upper part and the lower part in a manner which is known per se.

According to one object, the insulating film is formed in such a way that it lies between the first and the second circumferential with a cylindrical section, with the cylindrical section preferably having a base facing the upper part, the said base running parallel to the upper part and having a central opening through which the switching mechanism comes into contact with the upper part.

This ensures that the upper part and the lower part are reliably electrically insulated from one another and nevertheless the switching mechanism comes into contact with the upper part.

In this case, it is particularly preferred when the insulating film is deep-drawn, it preferably being possible for the insulating film to be of self-adhesive design.

If the insulating film is deep-drawn before assembly, it already has a pot-like structure, and therefore assembly of the new switch is even simpler.

The temperature-dependent switching mechanism is first inserted into the lower part, the deep-drawn insulating film is then placed over the lower part in such a way that the switching mechanism can come into contact with the upper part through the central opening in the base of the insulating film.

The upper part is then placed over the insulating film.

If the insulating film is of self-adhesive design, reliable mechanical connection between the lower part and the insulating film and also between the insulating film and the upper part can be ensured, for example, by pressure and heat being applied after the assembly of the new switch as just described. At the same time, this ensures that the interior of the switch and therefore the switching mechanism is sealed off against the ingress of moisture, vapors and dust, as well as liquids.

In addition or as an alternative, the lower part and the upper part can also be pressed together, with the pressing preferably being performed in an interlocking manner.

As an alternative, it is also possible to latch the lower part and the upper part to one another, that is to say to provide a kind of snap-action connection between the lower part and the upper part.

To this end, it is possible, for example, to provide a circumferential bead on the outside of the circumferential wall of the lower part and an associated circumferential groove on the inside of the circumferential wall of the upper part, it obviously being necessary for an insulating film to be interposed in this case too.

In one embodiment, the switch according to the invention which is characterized in that firstly it can be produced in a cost-effective manner, the upper part and the lower part can be deep-drawn parts, with, at the same time, the outer circumferential recessed shoulders also being formed during the deep-drawing process.

The temperature-dependent switching mechanism can either be a switching mechanism with a moving contact part, as described in EP 0 651 411 B1, or else a switching mechanism with a contact bridge can be used, as described in DE 26 44 411 A1.

In one embodiment, a first contact surface is provided on an inner face of the upper part and a second contact surface is provided on an inner face of the lower part, when the switching mechanism, as a function of its temperature, establishes or opens an electrically conductive connection between the first and the second contact surface, with the switching mechanism preferably comprising a bimetallic snap-action disc and a spring snap-action disc on which a moving contact part is arranged, and when the moving contact part interacts with the first contact surface and the spring snap-action disc interacts with the second contact surface, with the bimetallic snap-action disc interacting with the spring snap-action disc in such a way that, as a function of its temperature, it lifts the moving contact part away from the first contact surface.

This design is known per se from EP 0 651 411 B1. It has the advantage that the bimetallic snap-action disc is not mechanically loaded and is without current in the closed state of the switch.

According to another object, the moving contact part is held captively on, preferably welded to, the spring snap-action disc, and when preferably the bimetallic snap-action disc is held captively with play on the contact part.

The advantage of these measures is that the switching mechanism can be preassembled and stored as well as handled and tested, as it were, completely outside the switch. Since the switching mechanism comprising the spring snap-action disc, the moving contact part and the bimetallic snap-action disc forms a unit, it can also be simply inserted into the lower part as such during assembly of the switching mechanism, with there being no risk of the bimetallic snap-action disc slipping onto the moving contact part or becoming stuck on the moving contact part during insertion.

In this case, the bimetallic snap-action disc is held with play on the contact part in order to keep the bimetallic snap-action disc completely or at least largely free of mechanical forces in the closed state of the switch. This ensures that the transition temperature of the bimetallic snap-action disc does not shift on account of mechanical loadings.

In one embodiment, a lateral connecting web is provided on the spring snap-action disc, said connecting web being mechanically and electrically conductively attached, preferably welded, to the second contact surface.

This measure firstly provides the advantage that the preassembled switching mechanism can be held by means of the connecting web, for example on a conveyor belt, until it has been completely assembled and tested. The connecting web is then separated off from the conveyor belt and the switching mechanism can be grasped at the connecting web and inserted into the lower part.

In addition to this advantage in respect of handling and test options, the connecting web provides the further advantage that, after the connecting web is attached, preferably welded, to the second contact surface, a mechanically and electrically conductively reliable connection is established.

This ensures firstly that the switching mechanism is situated fixedly in the lower part, so that it can no longer become stuck during the subsequent mounting of the insulating film and of the upper part.

Furthermore, the welded connecting web ensures a very low transfer resistance between the spring snap-action disc and the lower part of the housing, so that the total contact resistance of the switch is considerably reduced in comparison to that known in the prior art.

When the moving contact part is also welded to the spring snap-action disc, a very low transfer resistance can be observed in this case, so that the only remaining unwelded contact is the contact between the moving contact part and the stationary contact.

A very low transfer resistance can be ensured in this case by corresponding galvanization of the surfaces of these contacts.

In addition to these advantages in respect of electrical contact resistance and mechanical design, it is further advantageous in this case that the functioning of the switch has once again become less sensitive to a pressure which is exerted from the outside. A minor change in the geometry of the lower part, which is produced as a deep-drawn part, now no longer leads to the electrical contact between the spring snap-action disc and the lower part, that is to say the second contact surface, possibly being impaired.

Further features and advantages can be gathered from the description and the appended drawing.

It goes without saying that the features mentioned above and those yet to be explained below can be used not only in the respectively given combinations but also in other combinations or on their own, without departing from the scope of the present invention.

### BRIEF DESCRIPTION OF THE DRAWINGS

Embodiments of the invention are illustrated in the drawing and explained in greater detail in the description below. In the drawings

FIG. 1 shows a schematic sectional illustration of a side view of the new switch in a first embodiment;

FIG. 2 shows, in an illustration similar to FIG. 1, a further embodiment in which a switching mechanism is used, the spring snap-action disc of the said switching mechanism being equipped with a lateral connecting web;

FIG. 3 shows a schematic, greatly enlarged illustration of a detail of a further embodiment for the design of the lower part and the upper part in the region of the outer, recessed circumferential shoulders;

FIG. 4 shows a plan view of the switch from FIG. 2; and

FIG. 5 shows a view similar to FIG. 1 of a new switch in a further embodiment in which the current is conducted via a contact plate.

### DESCRIPTION OF PREFERRED EMBODIMENTS

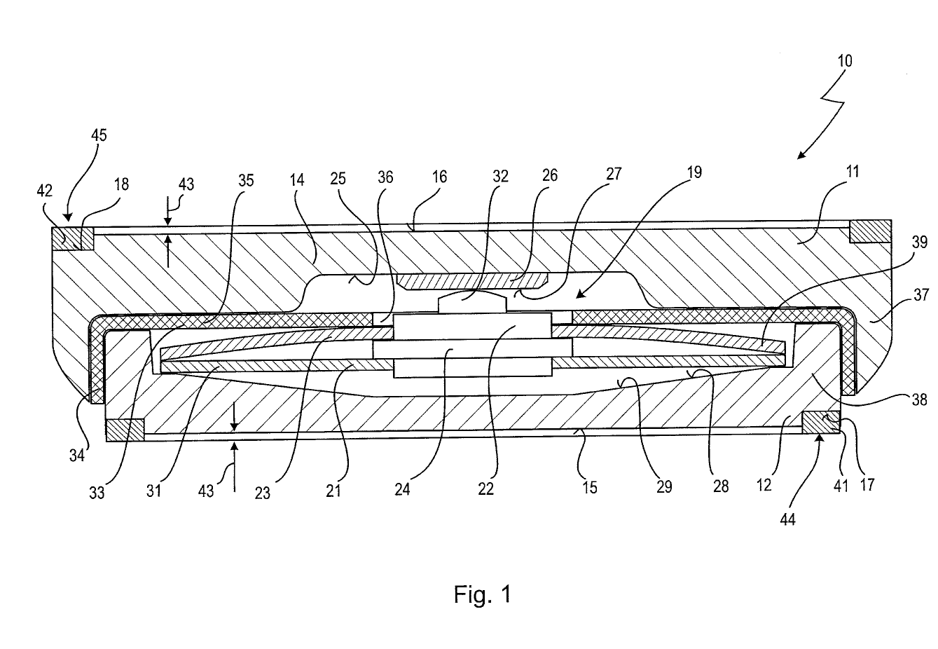

FIG. 1 shows a schematic lateral section, which is not true to scale, through a temperature-dependent switch 10 having a housing 11. The housing 11 has a deep-drawn lower part 12 and a similarly deep-drawn upper part 14.

An outer surface 15 which forms the base of the lower part 12 is provided on the lower part 12. An outer surface 16 which forms the cover region of the upper part 14 is provided on the upper part 14.

A recessed, outer circumferential shoulder 17 on the lower part 12 is used as a first outer connection of the switch 10 and a recessed, outer circumferential shoulder 18 on the upper part 14 is used as a second outer connection of the switch 10.

Since the lower part 12 and the upper part 14 are composed of conductive material, the circumferential shoulders 17 and 18 are used, specifically directly, for the outer connection.

A temperature-dependent switching mechanism 19 is arranged within the housing 11, the said temperature-dependent switching mechanism comprising a spring snap-action disc 21 which is fitted with a moving contact part 22 over which a bimetallic snap-action disc 23 is placed.

In this embodiment, the contact part 22 is inserted loosely into the spring snap-action disc, with the bimetallic snap-action disc likewise being placed loosely on a collar 24 of the moving contact part 22.

The upper part 14 is fitted on its inner face 25 with a stationary contact 26 on which a first contact surface 27 is formed. The lower part 12 has, on its inner face 28, a second contact surface 29 on which the spring snap-action disc 21 is supported by way of its edge 31.

The moving contact part 22 is supported on the stationary contact 26 by way of its dome-like tip 32.

In this way, an electrically conductive connection is produced between the recessed shoulder 17, the lower part 12, the spring snap-action disc 21, the moving contact part 22, the stationary contact 26, the upper part 14 and the circumferential shoulder 18 when the switch is closed, that is to say is in the state shown in FIG. 1.

Since the lower part 12 and the upper part 14 are produced from electrically conductive material, an insulating film 33 is arranged between them.

The insulating film 33 has acquired a cup-like shape as result of deep-drawing, the said cup-like shape comprising a cylindrical section 34 and a base 35 which closes off the cylindrical section 34 at the top and runs parallel to the upper part 14 and in which a central opening 36 is provided, the switching mechanism 19 coming into contact with the stationary contact 26 through the said opening.

A first circumferential wall 37 is provided on the upper part 14 and a second circumferential wall 38 is provided on the lower part 12, and therefore the upper part 14 and the lower part 12 likewise have a pot- or cup-like structure.

The cylindrical section 34 of the insulating film 33 therefore separates the two circumferential walls 37 and 38 from one another, while the base 35 of the insulating film 33 insulates the circumferential wall 38 of the lower part 12 from the inner face 25 of the upper part 14.

As already mentioned, the switch 10 in the position shown in FIG. 1 is in the closed state.

If the temperature of the switch 10 and therefore of the bimetallic snap-action disc 23 now increases, the bimetallic snap-action disc deforms, and changes from the shown convex shape to a concave shape in which it is supported by way of its edge 39 on the base 35 of the insulating film 33. As a result, it presses the moving contact part 22 away from the stationary contact 26 against the force of the spring snap-action disc 21 at the same time, and therefore the switch 10 is opened.

When the temperature of the bimetallic snap-action disc 23 drops below the transition temperature again, it returns to the convex shape shown in FIG. 1, and therefore the spring snap-action disc 21 can bring the moving contact part 22 back into contact with the stationary contact 26.

A pressure-uptaking structure 41 or, respectively, 42 is provided on the recessed shoulder 17 and on the recessed shoulder 18 in each case and projects beyond the outer surface 15 or, respectively, the outer surface 16 by an amount which is indicated by 43. This amount 43 corresponds to 1/10 to 1/100 mm.

If in FIG. 1 pressure is now exerted on the switch 10 from above and/or below by means of a bearing surface of an appliance which is to be protected, this bearing surface comes into contact with the pressure-uptaking structure 41 or, respectively, 42, while the outer surfaces 15 and 16 are not exposed to any direct pressure.

The pressure which is exerted on the pressure-uptaking structures 41 and 42 is conducted into the circumferential walls 38 and 37, and therefore the lower part 12 and the upper part 14 are not deformed.

The pressure-uptaking structures 41 and 42 therefore ensure that the lower part 12 and the upper part 14 are protected against deformations, whereas, on the other hand, the projecting length 43 is so low that the thermal connection of the switch 10 to the electrical appliance which is to be protected is still sufficient.

Therefore, it is no longer necessary to design the lower part 12 and the upper part 14 as turned parts, instead they can be produced as deep-drawn parts. In the case of production in this way, the outer shoulders 17 and 18 are produced together at the same time, and therefore no additional production step is required for this purpose.

While in the embodiment of FIG. 1 the pressure-uptaking structures 41 and 42 are mounted on the recessed shoulders 17 and 18 only afterwards, the invention also provides pressure-uptaking structures in the region of the circumferential walls 38 and 37 which are formed integrally therewith and which project downwards or, respectively, upwards beyond the outer surface 15 and, respectively, 16 by the amount 43.

However, in the present case, pressure-uptaking structures 41 and 42 which can be subsequently mounted are used because they simultaneously also serve for the outer connection of the switch 10.

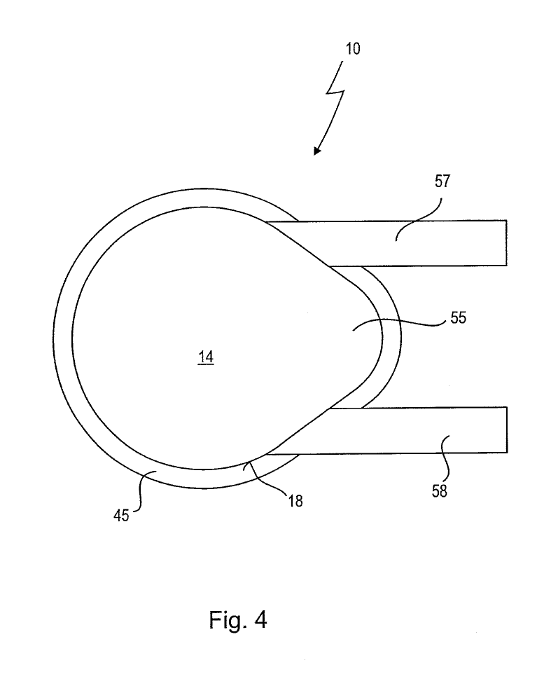

To this end, the pressure-uptaking structures 41 and 42 are provided with annular structures 44 and 45 which are connected to connection tabs in a manner which is not shown in FIG. 1 and as is known in principle from EP 0 651 414 B1 and will be explained once again below with reference to FIG. 4.

It should be noted that the insulating film 33 is self-adhesive, and therefore, after the assembly of the new switch and possibly after pressure or heat being applied, it connects the upper part 14 and the lower part 12 firmly to one another and protects against the ingress of contaminants of any kind. In addition or as an alternative, the lower part 12 and the upper part 14 can also be pressed or latched together.

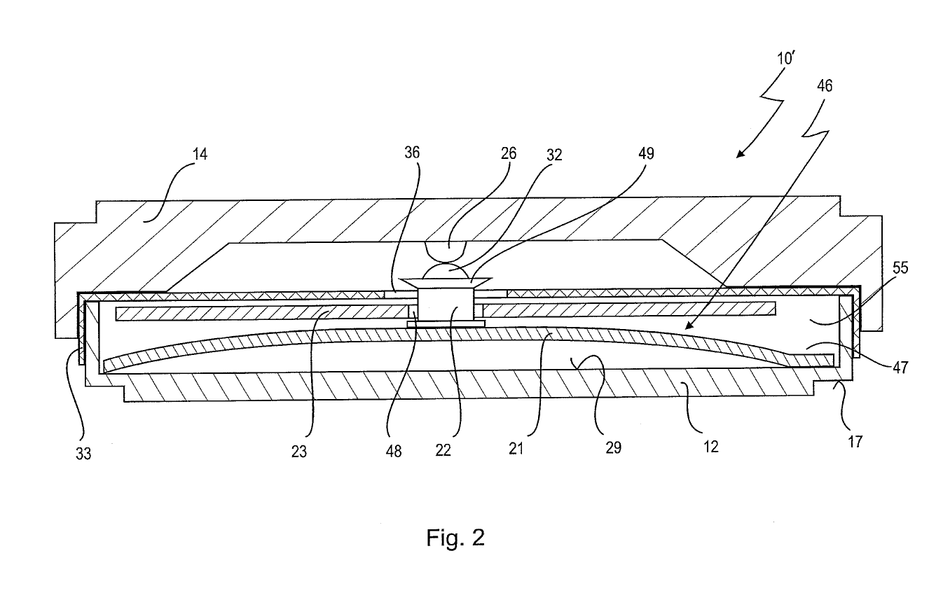

FIG. 2 shows, in a view like that in FIG. 1, a temperature-dependent switch 10′, the lower part 12 and the upper part 14 of this temperature-dependent switch being provided with the circumferential shoulders 17 and 18 known from FIG. 1 on which pressure-uptaking structures can subsequently be mounted.

In contrast to the switch 10 from FIG. 1, the switch 10′ from FIG. 2 has a temperature-dependent switching mechanism 46 in which the spring snap-action disc 21 is provided with a lateral connecting web 47 which is welded to the inner face 28 of the lower part 12, this inner face forming the second contact surface 29.

In a variation of the design of FIG. 1, with switch 10′ the moving contact part 22 is welded onto the spring snap-action disc 21 by way of its collar 24, with the bimetallic snap-action disc 23 being placed over the contact part 22 by way of its passage opening 48 and being held there with play by a peripheral flange which is merely indicated by 49.

In this way, the switching mechanism 46 is a unit comprising the parts spring snap-action disc 21, contact part 22 and bimetallic snap-action disc 23 which are captively connected to one another. This switching mechanism 46 which is preassembled in this way can be held on the connecting web 47 and supplied, for example, to an external functional checking means before being inserted into the lower part 12. The connecting web 27 is then welded to the inner face 28 of the lower part 12, and therefore the switching mechanism 46 is situated mechanically immovably in the lower part 12, but the bimetallic snap-action disc 23 can deform as before without being mechanically impeded.

Welding the connecting web 47 to the inner face 28 also ensures a very low transfer resistance between the lower part 12 and the switching mechanism 46. Since the moving contact part 22 is also welded to the spring snap-action disc 21, the transfer resistance there is also low to negligible.

Therefore, when the switch 10′ is assembled, the switching mechanism 46 is first inserted into the lower part 12 and the connecting web 46 is then connected to the inner face 28, for example by spot-welding.

The insulating film 33 is then placed over the lower part 12, and therefore the moving contact part 22 protrudes upwards through the central opening 36.

The upper part 14, which is designed in a pot-like manner in exactly the same way as the lower part 12 and the insulating film 33, is then placed, from above, onto the switch 10′ which has been preassembled so far.

The upper part 14, the insulating film 33 and the lower part 12 are then captively connected to one another by the action of pressure and/or heat, it being possible to make provision for the insulating film 33 to be of self-adhesive design for this purpose.

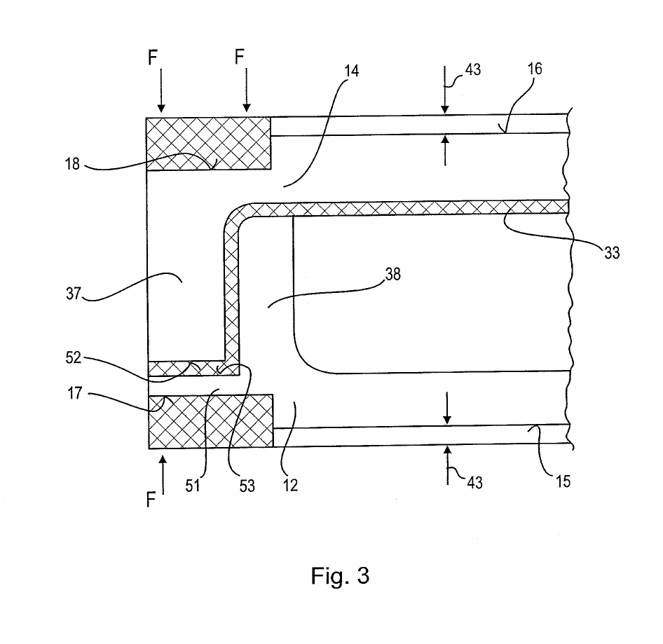

The region between the circumferential walls 37 and 38 is illustrated in FIG. 3 on an enlarged scale and in detail for one embodiment of switch 10, 10′.

In FIG. 3, the design is chosen such that the circumferential wall 38 of the lower part 12 has a lateral flange 51 on which the recessed circumferential shoulder 17 is formed.

In this way, the circumferential wall 37 of the upper part 14, by way of its end face 52, is situated opposite an annular bearing surface 53 on the flange 51.

A pressure-uptaking structure 41 and, respectively, 42 are now in each case placed on the shoulder 17 and the shoulder 18 again, the said pressure-uptaking structures projecting beyond the outer surface 15 and, respectively, 16 by the amount 43.

The shoulders 17 and 18 are now designed to be so broad in the direction parallel to the bearing surfaces 15 and 16 that pressure which is exerted on them and is indicated by arrows F is introduced into both circumferential walls 37 and 38.

FIG. 4 further illustrates a plan view of the switch 10 from FIG. 2. The switch 10 does not have a circular structure in outline but rather is provided with a convexity 55 in which the connecting web 47 is arranged according to FIG. 2 and by means of which the spring snap-action disc 21 is welded to the inner face 28.

FIG. 4 shows a plan view of the switch 10, and therefore the cover 14 with its circumferential shoulder 18 can be seen, the annular structure 45 which is known from FIG. 1 being placed onto the said shoulder and being mechanically and electrically conductively connected.

This annular structure 45 is integrally connected to a connection lug 57.

The annular structure 45 now conducts the current directly into the connection lug 57; it therefore also serves as an outer connection.

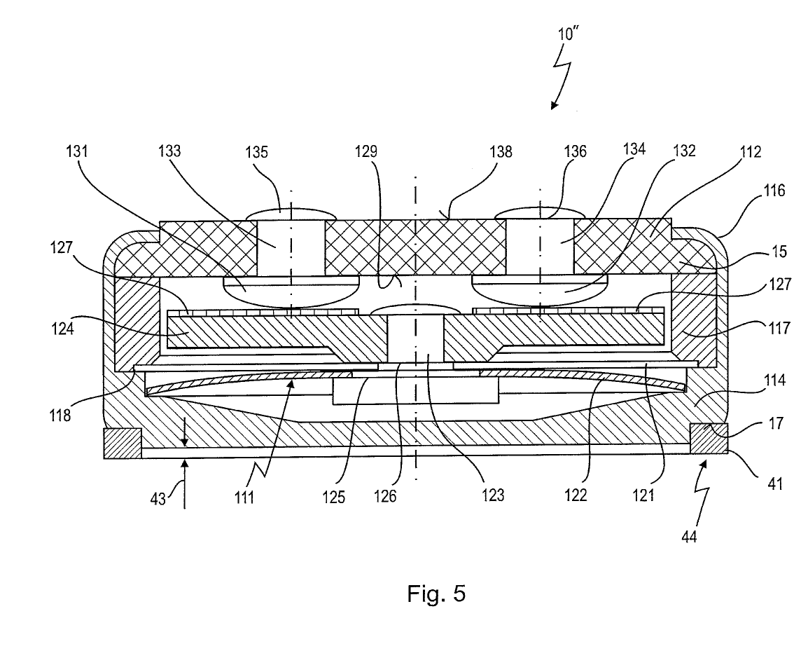

A further connection lug 58 is arranged on the lower face (not shown in FIG. 4) of the switch 10, said further connection lug having the annular structure 45 which is known from FIG. 1 and is attached to the circumferential shoulder 17.

Whereas the switches 10 and 10′ from FIGS. 1 and 2 are provided with a switching mechanism 19, 46 in which the current flows through the spring snap-action disc, FIG. 5 shows a switch 10″ in which the current is conducted through a contact plate, and therefore this switch 10″ can switch higher currents.

In FIG. 5, the temperature-dependent switch 10″ comprises a temperature-dependent switching mechanism 111 which is accommodated in a housing 112.

The housing 112 comprises a lower part 114 and an upper part 115 which closes the said lower part and is held on the lower part 114 by a beaded edge 116 of the said lower part. A ring 117 is arranged between the lower part 114 and the upper part 115, the said ring being supported on a projection 118 of the lower part 114 and there guiding a spring snap-action disc 121 of the switching mechanism 111 at its edge.

In addition to the spring snap-action disc 121, the switching mechanism 111 also comprises a bimetallic snap-action disc 122, a pin-like rivet 123 passing centrally through the said bimetallic snap-action disc and the spring snap-action disc 121, the said bimetallic snap-action disc and the said spring snap-action disc being mechanically connected to a current transfer element in the form of a contact plate 124 by the said rivet. The rivet 123 has a first projection 125 on which the bimetallic snap-action disc 122 is seated with radial and axial play, wherein a second projection 126 is provided, the spring snap-action disc 121 likewise being seated on the said second projection with radial and axial play.

The bimetallic snap-action disc 122 is supported on the inside of the lower part 114 by way of its circumferential edge.

The abovementioned contact plate 124 has, in the direction of the upper part 115, two contact surfaces 127 which are electrically connected to one another and have a large surface area and interact with two stationary contacts 131, 132 which are arranged on the inner face 129 of the upper part 115 and are inner heads of contact rivets 133, 134 which pass through the upper part 115 and, by way of their outer heads 135, 136 on the outer surface 138 of the upper part 115, serve for outer connection.

In the switching position shown in FIG. 5, the spring snap-action disc 121 and the bimetallic snap-action disc 122 press the contact plate 124 against the stationary contacts 131 and 132, and these are therefore connected to one another by means of the contact surfaces 127; therefore, the switch 10″ is closed.

If the temperature of the bimetallic snap-action disc 122 increases above its response temperature, it snaps over from the shown convex shape into a concave shape and, in the process, is supported by way of its edge in the region of the ring 117 and pulls the contact plate 124 away from the stationary contacts 131, 132 against the force of the spring snap-action disc 121; the switch 10″ is now open.

The switch described up until this point is known from DE 26 44 411 C2 and DE 198 27 113 C2. If the temperature is now lowered again, the switch known from DE 26 44 411 C2 would snap back into the closed state which is shown in FIG. 1 again.

As in the case of the switch which is known from DE 198 27 113 C2, the upper part 115 is produced from a PTC thermistor material, that is to say constitutes a PTC resistor which is electrically connected between the stationary contacts 131, 132. The upper part 115 therefore acts as a self-holding resistor, as has already been described in detail above.

An outer, circumferential, recessed shoulder 17 is also provided on the outside of the lower part 114 in the case of the switch 10″ too, the pressure-transferring structure 41 being arranged on the said shoulder and projecting downwards beyond the outer surface 139 of the lower part 114 by the amount 43.

The pressure-uptaking structure 41 again comprises an annular structure 44 which, however, in this case does not serve for outer connection but rather only for diverting a pressure, which is exerted from the outside, into the edge 116 and/or the ring 117.

Therefore, what is claimed is:

1. A temperature-dependent switch comprising:
a housing which has an upper part comprising an outside with a first outer surface and a lower part comprising an outside with a second outer surface, and
a temperature-dependent switching mechanism which is arranged in the housing and, as a function of its temperature, establishes or opens an electrically conductive connection between two outer connections provided at the housing,
a pressure-uptaking structure being provided on the outside of at least one of the upper part and the lower part, said pressure-uptaking structure protruding approximately perpendicularly outwards beyond the outer surface of said at least one of the upper part and the lower part.

2. The switch of claim 1, wherein the pressure-uptaking structure projects beyond said outer surface of said at least one part by less than 1/10 mm.

3. The switch of claim 1, wherein the first outer surface is a cover surface and the second outer surface is a bottom surface.

4. The switch of claim 1, wherein an outer shoulder is provided at least at one of the upper part and the lower part, said outer shoulder being recessed in relation to the outer surface of said at least one of the upper part and the lower part, the pressure-uptaking structure being attached to said shoulder.

5. The switch of claim 4, wherein the pressure-uptaking structure comprises an annular structure.

6. The switch of claim 5, wherein the pressure-uptaking structure is connected to a connection lug.

7. The switch of claim 6, wherein the pressure-uptaking structure is integrally connected to said connection lug.

8. The switch of claim 1, wherein a first circumferential wall is provided on the upper part and a second circumferential wall is provided on the lower part, said first circumferential wall engaging over the said second circumferential wall.

9. The switch of claim 1, wherein the upper part and the lower part are produced from electrically conductive material, an insulating film being arranged between the upper part and the lower part.

10. The switch of claim 8, wherein the upper part and the lower part are produced from electrically conductive material, an insulating film being arranged between the upper part and the lower part.

11. The switch of claim 10, wherein the insulating film comprises a cylindrical section that it lies between the first and the second circumferential wall.

12. The switch according to claim 11, wherein the cylindrical section is provided with a base facing the upper part, said base running parallel to the upper part and having a central opening through which the switching mechanism comes into contact with the upper part.

13. The switch of claim 10, wherein the insulating film is deep-drawn.

14. The switch of claim 10, wherein the insulating film is of self-adhesive design.

15. The switch of claim 1, wherein the upper part and the lower part are pressed together in an interlocking manner.

16. The switch of claim 1, wherein a first contact surface is provided on an inner face of the upper part and a second contact surface is provided on an inner face of the lower part, the switching mechanism, as a function of its temperature, establishing or opening an electrically conductive connection between the first and the second contact surface.

17. The switch of claim 16, wherein the switching mechanism comprises a bimetallic snap-action disc and a spring snap-action disc on which a moving contact part is arranged, the moving contact part interacting with the first contact surface and the spring snap-action disc interacting with the second contact surface, the bimetallic snap-action disc interacting with the spring snap-action disc in such a way that, as a function of its temperature, it lifts the moving contact part away from the first contact surface.

18. The switch of claim 17, wherein the moving contact part is held captively on the spring snap-action disc.

19. The switch of claim 18, wherein the moving contact part is welded to the spring snap-action disc.

20. The switch of claim 18, wherein, the bimetallic snap-action disc is held captively with play on the contact part.

21. The switch of claim 17, wherein a lateral connecting web is provided on the spring snap-action disc, said connecting web being mechanically and electrically conductively attached to the second contact surface.

22. The switch of claim 21, wherein said connecting web is welded to the second contact surface.

23. The switch of claim 1, wherein the upper part is a deep-drawn part.

24. The switch of claim 1, wherein the lower part is a deep-drawn part.

25. A temperature-dependent switch comprising:
a housing which has an upper part comprising an outside with a cover surface and a lower part comprising an outside with a bottom surface, and
a temperature-dependent switching mechanism which is arranged in the housing and, as a function of its temperature, establishes or opens an electrically conductive connection between two outer connections provided at the housing,
a pressure-uptaking structure being provided on the outside the lower part, said pressure-uptaking structure protruding approximately perpendicularly outwards beyond the bottom surface,
wherein an outer shoulder is provided at the lower part, said outer shoulder being recessed in relation to the bottom surface of the lower part, the pressure-uptaking structure being attached to said shoulder.

26. A temperature-dependent switch comprising:
a housing which has an upper part comprising an outside with a cover surface and a lower part comprising an outside with a bottom surface, and
a temperature-dependent switching mechanism which is arranged in the housing and, as a function of its temperature, establishes or opens an electrically conductive connection between two outer connections provided at the housing,
a pressure-uptaking structure being provided on the outside the upper part, said pressure-uptaking structure protruding approximately perpendicularly outwards beyond the cover surface,
wherein an outer shoulder is provided at the upper part, said outer shoulder being recessed in relation to the cover surface of the upper part, the pressure-uptaking structure being attached to said shoulder.

27. The switch of claim 26, wherein a pressure-uptaking structure being provided on the outside the lower part, said pressure-uptaking structure protruding approximately perpendicularly outwards beyond the bottom surface, and wherein an outer shoulder is provided at the lower part, said outer shoulder being recessed in relation to the bottom surface of the lower part, the pressure-uptaking structure being attached to said shoulder.
